(19) United States
(12) Patent Application Publication
(10) Pub. No.: US 2026/0366115 A1
(43) Pub. Date: Nov. 19, 2026

(54) NON-ORIENTED ELECTRICAL STEEL SHEET AND MANUFACTURING METHOD THEREFOR

(71) Applicant: POSCO CO., LTD., Pohang-si, Gyeongsangbuk-do (KR)

(72) Inventor: Se-Il Lee, Incheon (KR)

(73) Assignee: POSCO CO., LTD., Pohang-si, Gyeongsangbuk-do (KR)

(21) Appl. No.: 19/133,679

(22) PCT Filed: Nov. 24, 2023
(86) PCT No.: PCT/KR2023/019143

§ 371 Date: May 28, 2025

(30) Foreign Application Priority Data
Dec. 21, 2022 (KR) 10-2022-0181007

(51) Int. Cl. C22C 38/34; C21D 1/74; C21D 6/00; C21D 8/1216; C21D 8/1244; C21D 9/46; C22C 38/00; C22C 38/02; C22C 38/04; C22C 38/06; C22C 38/22; C22C 38/24; C22C 38/26; C22C 38/28; C22C 38/32; H01F 1/147

(52) U.S. Cl. CPC C22C 38/34; C21D 1/74; C21D 6/002; C21D 6/005; C21D 6/008; C21D 8/1222; C21D 8/1233; C21D 8/1261; C21D 9/46; C22C 38/001; C22C 38/002; C22C 38/004; C22C 38/008; C22C 38/02; C22C 38/04; C22C 38/06; C22C 38/22; C22C 38/24; C22C 38/26; C22C 38/28; C22C 38/32; H01F 1/14775; H01F 1/14791; C22C 2202/02

(57) ABSTRACT

The present invention relates to a non-oriented electrical steel sheet and a manufacturing method therefor. One aspect of the invention aims to provide a non-oriented electrical steel sheet that exhibits excellent iron loss prevention and magnetic anisotropy under high flux density and high-frequency conditions, and a manufacturing method therefor. According to an aspect of the present disclosure, a non-oriented electrical steel sheet having excellent iron loss and magnetic anisotropy under high magnetic flux and high frequency conditions, and a method of manufacturing the same may be provided.

### TECHNICAL FIELD

The present disclosure relates to a non-oriented electrical steel sheet and a method of manufacturing the same.

### BACKGROUND ART

Electric vehicles and electric-powered transportation has been used to replace internal combustion engines to reduce greenhouse gas emissions. Currently, 50% or more of all electrical energy generated may be consumed by electric motors for power, and efficient use of electricity may be important in order for internal combustion engines to be replaced by electric motors in the future. In particular, along with the improvement of electric motor performance, miniaturization and weight reduction have also been implemented, and motors forming magnetic flux in the axial direction may also draw attention. These electric motors may be used to resolve space constraints and improve performance of various electric devices including existing electric vehicles, electric two-wheeled vehicles, electric airplanes, and electric ships, and thus, high efficiency may be necessary. Also, interest in high-functioning and high-efficiency motors for home appliances, robots, and industrial motors has continued along with technological development and changes in the market and thus, efficient use of electric energy may be higher than ever.

In order to improve the efficiency of an electric motor, optimization in the entire areas from material selection to design, assembly, and control may be important. In particular, in terms of material, magnetic properties of an electrical steel may be the most important, such that there has been a high demand for low iron loss and high magnetic flux density. As for automobile drive motors or air conditioner compressor motors driven in the commercial frequency region and also in the high-frequency region, low iron loss properties at high frequencies may be important. Also, in the case of a small high-power motor having a yoke with a narrow width, high magnetic flux may be formed in the teeth area of the motor and also in the yoke area to obtain high torque when the motor is operated, and thus, improvement of iron loss at high magnetic flux at high frequencies may be important for improving the motor efficiency.

Generally, as for electrical steel, eddy current loss may be reduced by adding a large amount of non-resistive elements such as Si, Al, and Mn and reducing the grain size during the manufacturing process. Since eddy current passes only through a surface layer of the steel sheet as the frequency increases, high-frequency iron loss may be improved by increasing resistivity element of the surface layer. However, the general manufacturing method may be effective in controlling iron loss at a magnetic flux of around 1.0 T, and a method of reducing iron loss at high magnetic flux may not be known.

### DETAILED DESCRIPTION OF PRESENT DISCLOSURE

### Technical Problems to Solve

An aspect in the present disclosure is to provide a non-oriented electrical steel sheet having excellent iron loss and magnetic anisotropy under high magnetic flux and high frequency conditions, and a method of manufacturing the same.

### Solution to Problem

According to an embodiment of the present disclosure, a non-oriented electrical steel sheet includes, by weight %, by weight %, Si: 1.5 to 6.5%, Al: 0.0005 to 3.5%, Mn: 0.01 to 3.0%, Cr: 0.005 to 5.0%, S: 0.0005 to 0.03%, and a balance of Fe and inevitable impurities, wherein a Goss orientation fraction in a region from a surface to 1/10 t (t: thickness of the steel sheet) in a thickness direction is 3 area % or less, and wherein a density of inclusions in a region from a surface to 1/50 t (t: thickness of the steel sheet) in the thickness direction is equal to or less than a density of inclusions in the other region.

The non-oriented electrical steel sheet further includes one or more of P: 0.005 to 0.08% and Sn: 0.01 to 0.2%.

The non-oriented electrical steel sheet further includes one or more of C: 0.005% or less (excluding 0%), N: 0.005% or less (excluding 0%), 0:0.005% or less (excluding 0%) and Ti: 0.01% or less (excluding 0%).

The non-oriented electrical steel sheet further includes one or more of Mo: 0.1% or less (excluding 0%), B: 0.0050% or less (excluding 0%), V: 0.050% or less (excluding 0%), Ca: 0.010% or less (excluding 0%), Nb: 0.0050% or less (excluding 0%) and Mg: 0.0050% or less (excluding 0%).

The non-oriented electrical steel sheet further includes one or more of Sb: 0.1% or less (excluding 0%), Ni: 0.05% or less (excluding 0%), Cu: 0.005 to 0.2% and Zn: 0.01% or less (excluding 0%).

The non-oriented electrical steel sheet further includes 0.20% or less (excluding 0%) of one or more of Bi, Pb, Ge and As individually or in combination.

The non-oriented electrical steel sheet satisfies relational expression 1 as below:

Si>Al+Mn [Relational expression 1]

In the non-oriented electrical steel sheet, a Goss orientation fraction in the thickness direction in an entire region is 5 area % or less.

The non-oriented electrical steel sheet has an iron loss (W15/1000 L) of 150 W/Kg or lower, and an iron loss (W15/1000 C) of 150 W/Kg or lower.

The non-oriented electrical steel sheet satisfies 2×(W15/1000 C−W15/1000 L)/(W15/1000 C+W15/1000 L)<0.1.

According to another embodiment of the present disclosure, a method of manufacturing a non-oriented electrical steel sheet includes heating a slab including, by weight %, Si: 1.5 to 6.5%, Al: 0.0005 to 3.5%, Mn: 0.01 to 3.0%, Cr: 0.005 to 5.0%, S: 0.0005 to 0.03%, and a balance of Fe and inevitable impurities at 1050 to 1220 °C; finishing hot-rolling the slab and obtaining a hot-rolled sheet; hot-rolled sheet annealing the hot-rolled sheet for 30 to 300 seconds at 850 to 1150 °C; cold-rolling the hot-rolled sheet annealed hot-rolled sheet and obtaining a cold-rolled sheet; heating the cold-rolled sheet; and final annealing the heated cold-rolled sheet at 600 to 1150 °C for 10 to 300 seconds, wherein, in the cold-rolling, [Relational expression 2] is satisfied, wherein, in the heating, a heating rate in a temperature range of 300 to 500 °C is 5 to 150 °C/s, wherein, in the final annealing, a gas atmosphere includes, by volume %, hydrogen: 15 to 99.99%, oxygen: 0.0001 to 0.0030%, and a remainder of inert gas, and wherein, in the final annealing, an oxygen content in the gas atmosphere in a temperature range of 800 to 1100 °C is 1 to 1.5 times higher than an oxygen content in a temperature range of 500 to 750 °C.

highest temperature on surface of cold-rolled sheet during cold rolling<200×cold reduction ratio/100+40 [Relational expression 2]

The slab further includes one or more of P: 0.005 to 0.08% and Sn: 0.01 to 0.2%.

The slab further includes one or more of C: 0.005% or less (excluding 0%), N: 0.005% or less (excluding 0%), O: 0.005% or less (excluding 0%) and Ti: 0.01% or less (excluding 0%).

The slab further includes one or more of Mo: 0.1% or less (excluding 0%), B: 0.0050% or less (excluding 0%), V: 0.050% or less (excluding 0%), Ca: 0.010% or less (excluding 0%), Nb: 0.0050% or less (excluding 0%) and Mg: 0.0050% or less (excluding 0%).

The slab further includes one or more of Sb: 0.1% or less (excluding 0%), Ni: 0.05% or less (excluding 0%), Cu: 0.005 to 0.2% and Zn: 0.01% or less (excluding 0%).

The slab further includes 0.20% or less (excluding 0%) of one or more of Bi, Pb, Ge and As individually or in combination.

The slab satisfies relational expression 1 as below:

Si>Al+Mn [Relational expression 1]

The finishing hot-rolling is performed at 700 to 1050 °C.

The cold-rolling is performed with a cold reduction ratio of 35 to 98%.

In the cold rolling, a maximum rolling rate in one or more of first and second passes is 3 m/s or higher.

### Advantageous Effects of Invention

According to an aspect of the present disclosure, a non-oriented electrical steel sheet having excellent iron loss and magnetic anisotropy under high magnetic flux and high frequency conditions, and a method of manufacturing the same may be provided.

### BEST MODE FOR INVENTION

Hereinafter, a non-oriented electrical steel sheet according to an embodiment of the present invention may be described. First, an alloy composition may be described. The content of the alloy composition described below may be indicated in weight % unless otherwise indicated.

### Si: 1.5 to 6.5%

Si may increase resistivity of a material and may reduce iron loss. When the content of Si is less than 1.5%, the effect of improvement of high-frequency iron loss may be insufficient. When the content of Si exceeds 6.5%, hardness may increase and productivity and impact resistance may deteriorate. Accordingly, the content of Si may preferably have a range of 1.5 to 6.5%. A lower limit of the content of Si may preferably be 1.8%, and more preferably 2.0%. An upper limit of the content of Si may preferably be 6.0%, more preferably 5.0%, and most preferably 4.0%.

### Al: 0.0005 to 3.5%

Al may increase resistivity of the material and may reduce iron loss. When the Al content is less than 0.0005%, the amount of Al to exclude oxygen during steel manufacturing may be small, and inclusions may be formed excessively in steel, which may not be effective in reducing high-frequency iron loss, and fine nitrides may be formed on the surface, which may reduce magnetism. When the Al content exceeds 3.5%, there may be problems in all processes such as steelmaking and continuous casting, which may significantly reduce productivity. Accordingly, the Al content may preferably have a range of 0.0005 to 3.5%. A lower limit of the Al content may be 0.15% more preferably. An upper limit of the Al content may preferably be 3.0%, more preferably 2.5%, and most preferably 2.0%.

### Mn: 0.01 to 3.0%

Mn may increase resistivity of the material, thereby improving iron loss and forming sulfides, and Mn may stabilize austenite. When the content of the Mn is less than 0.01%, sulfides, which is MnS, may be finely precipitated in steel, which may reduce magnetism. When the content of the Mn exceeds 3.0%, the range of annealing temperatures in which an appropriate grain size for obtaining low high-frequency iron loss may be obtained may be limited. Also, saturation magnetic flux of the material may be lowered, and formation of {111} texture, which is particularly unfavorable to ferromagnetism, may be promoted, such that magnetic flux density may reduce. Accordingly, the content of Mn may preferably have a range of 0.01 to 3.0%. A lower limit of the Mn content may be more preferably 0.2%. An upper limit of the Mn content may be preferably 2.5%, more preferably 2.0%, and most preferably 1.5%.

### Cr: 0.005 to 5.0%

Cr may increase resistivity of the material and may reduce iron loss, and also, when the cold-rolling conditions and the final annealing conditions are properly controlled, Cr may be concentrated on the surface and may form a Cr-concentrated layer. When the Cr content is less than 0.005%, Cr may have a minimal effect on increasing resistivity and may form carbides by combining with C, or the like, which may be detrimental to magnetism. When Cr exceeds 5%, Cr may be evenly distributed throughout the entire thickness rather than concentrating on the surface, a decrease in magnetic flux density may occur throughout the steel sheet. Accordingly, the Cr content may preferably have a range of 0.005 to 5.0%. In terms of surface enrichment, a lower limit of Cr may more preferably be 0.04%. In terms of preventing the decrease in magnetic flux density, an upper limit of the Cr may preferably be 3.0%, more preferably 1.0%, and most preferably 0.3%.

### S: 0.0005 to 0.03%

S may be a strong segregating element and may form precipitates. When S is added in an appropriate amount, S may segregate on the surface and may react with oxygen in the atmosphere during annealing, thereby inhibiting growth of Goss grains on the surface. When the S content is less than 0.0005%, the surface segregation effect may not be sufficient. When the S content exceeds 0.03%, a FeS enriched layer may be formed on the surface, which may significantly deteriorate the surface quality. Accordingly, the S content may preferably have a range of 0.0005 to 0.03%. A lower limit of the S content may more preferably be 0.001%. An upper limit of the S content may preferably be 0.015%, more preferably 0.005%, and most preferably 0.0035%.

A remainder of the present disclosure is iron (Fe). However, in a general manufacturing process, inevitable impurities may be inevitably added from raw materials or an ambient environment, and thus, impurities may not be excluded. A person skilled in the art of a general manufacturing process may be aware of the impurities, and thus, the descriptions of the impurities may not be provided in the present disclosure.

The non-oriented electrical steel sheet of the present invention may further include one or more of P: 0.005 to 0.08% and Sn: 0.01 to 0.2%.

### P: 0.005 to 0.08%

P may be concentrated on the surface and may control a fraction of the internal oxide layer. When the content of the P is less than 0.005%, it may be difficult to form a uniform internal oxide layer. When the content of P exceeds 0.08%, a melting point of the Si-based oxide may change, and an internal oxide layer may form rapidly. Accordingly, the content of the P may preferably have a range of 0.005 to 0.08%. An upper limit of the P content may more preferably be 0.07%.

### Sn: 0.01 to 0.2%

Sn may be segregated on the surface and grain system of the steel sheet, may suppress surface oxidation during annealing and may improving texture. When the Sn content is less than 0.01%, it may be difficult to sufficiently obtain the above-mentioned effect. When the Sn content exceeds 0.2%, Sn may be segregated on the grain system, and may lower toughness, such that productivity may degrade compared to improvement of magnetism. Accordingly, the Sn content may preferably have a range of 0.01 to 0.2%. A lower limit of Sn content may more preferably be 0.02%. An upper limit of Sn content may preferably be 0.15%, more preferably 0.1%, and most preferably 0.07%.

The non-oriented electrical steel sheet of the present invention may further include one or more of C: 0.005% or less (excluding 0%), N: 0.005% or less (excluding 0%), 0:0.005% or less (excluding 0%) and Ti: 0.01% or less (excluding 0%).

### C: 0.005% or Less (Excluding 0%)

C may react with N, Ti, Nb, V, or the like, and may form fine carbides, which hinder grain growth and domain movement, and thus, an upper limit thereof may be limited to 0.005%.

### N: 0.005% or Less (Excluding 0%)

N may combine with Ti, Nb, V, or the like, and may form nitrides, and may may hinder grain growth, and thus, an upper limit thereof may be limited to 0.005%.

### O: 0.005% or Less (Excluding 0%)

O may react with Fe, Ti, Al, Mn, Cr, Si, V, or the like, and may form fine oxides, which hinder grain growth and domain movement, and thus, an upper limit thereof may be limited to 0.005%.

### Ti: 0.01% or Less (Excluding 0%)

Ti may combine with C, N, O, or the like, and may form fine nitrides or oxides, which hinder domain movement, and thus, an upper limit thereof may be limited to 0.01%.

Also, the non-oriented electrical steel sheet of the present invention may further include one or more of Mo: 0.1% or less (excluding 0%), B: 0.0050% or less (excluding 0%), V: 0.050% or less (excluding 0%), Ca: 0.010% or less (excluding 0%), Nb: 0.0050% or less (excluding 0%) and Mg: 0.0050% or less (excluding 0%).

### Mo: 0.1% or Less (Excluding 0%)

Mo may react with C, O, N, or the like, and may form fine carbides or nitrides, which adversely affect magnetism, and thus, an upper limit thereof may be limited to 0.1%.

### B: 0.0050% or Less (Excluding 0%)

B may react with C, O, N, or the like, and may form fine carbides or nitrides, which adversely affect magnetism, and thus, an upper limit thereof may be limited to 0.0050%.

### V: 0.050% or Less (Excluding 0%)

V may react with C, O, N, or the like, and may form fine carbides or nitrides, which adversely affect magnetism, and thus, an upper limit thereof may be limited to 0.050%.

### Ca: 0.010% or Less (Excluding 0%)

Ca may react with C, O, N, or the like, and may form fine carbides or nitrides, which adversely affect magnetism, and thus, an upper limit thereof may be limited to 0.010%.

### Nb: 0.0050% or Less (Excluding 0%)

Nb may react with C, O, N, or the like, and may form fine carbides or nitrides, which adversely affect magnetism, and thus, an upper limit thereof may be limited to 0.0050%.

### Mg: 0.0050% or Less (Excluding 0%)

Mg may react with C, O, N, or the like, and may form fine carbides or nitrides, which adversely affect magnetism, and thus, an upper limit thereof may be limited to 0.0050%.

The non-oriented electrical steel sheet of the present invention may further include one or more of Sb: 0.1% or less (excluding 0%), Ni: 0.05% or less (excluding 0%), Cu: 0.005 to 0.2% and Zn: 0.01% or less (excluding 0%).

### Sb: 0.1% or Less (Excluding 0%)

Sb may segregate in the grain system, and may be added to suppress the diffusion of nitrogen through the grain system, to suppress the {111} texture (texture) detrimental to magnetism, and to increase the {100} texture advantageous to improve magnetic properties. When the content of Sb exceeds 0.1%, Sb may hinder grain growth, which may lower magnetism and may deteriorate rolling properties. More specifically, the content of Sb may be 0.001 to 0.1%. More specifically, the content of Sb may be 0.005 to 0.08%

### Ni: 0.05% or Less (Excluding 0%)

Ni may react with impurity elements and may form fine sulfides, carbides, and nitrides, which have a detrimental effect on magnetism, and thus, an upper limit thereof may be limited to 0.05%. More specifically, the content of Ni may be 0.0001 to 0.050%. More specifically, the content of Ni may be 0.001 to 0.030%.

### Cu: 0.005 to 0.2%

Cu may form sulfides together with Mn. When the content of Cu is less than 0.005%, (Cu Mn) S may be finely precipitated, which may deteriorate magnetism. When the content of Cu exceeds 0.2%, high-temperature embrittlement may occur, which may cause cracks during casting or hot rolling. More specifically, the content of Cu may be 0.010 to 0.1%.

### Zn: 0.01% or Less (Excluding 0%)

Zn may act as an impurity and may deteriorate magnetism, and thus, an upper limit thereof may be limited to 0.01%. More specifically, the content of Zn may be 0.0001 to 0.01%. More specifically, the content of Zn may be 0.001 to 0.008%.

The non-oriented electrical steel sheet of the present invention may further include 0.20% or less (excluding 0%) of one or more of Bi, Pb, Ge and As individually or in combination.

When the above-mentioned elements are additionally added, the elements may segregate in the grain system, and may relieve stress concentration in the grain system during cold rolling, thereby inhibiting recrystallization of <111>//ND orientation grains in the subsequent recrystallization annealing process, and improving magnetic flux density. When the elements are added appropriately, the above-mentioned effect may be additionally obtained, but when the elements are included excessively, a large amount of segregation may occur, which may inhibit grain growth and may deteriorate magnetic flux density and iron loss. More specifically, one or more of Bi, Pb, Ge and As may be included in an amount of 0.0001 to 0.20% individually or in combination. More specifically, one or more of Bi, Pb, Ge and As may be included in an amount of 0.001 to 0.10% individually or in combination.

The non-oriented electrical steel sheet of the present invention may satisfy relational expression 1 as below:

Si>Al+Mn [Relational expression 1]

When relational expression 1 is not satisfied, magnetic anisotropy index, which is a physical property of the steel sheet, may not be sufficiently reduced, such that magnetic anisotropy at high frequencies may increase significantly.

As for the non-oriented electrical steel sheet of the present invention, it may be preferable that a Goss orientation fraction in the region from the surface to 1/10 t (t: thickness of the steel sheet) in the thickness direction may be 3 area % or less. The Goss orientation fraction may be an area fraction of grains having an orientation within 10° from the Goss orientation. The Goss orientation may have excellent magnetism in the rolling direction, but may have a great negative effect on the magnetism in the rolling vertical direction. Thus, it may be important to reduce the fraction of grains having the Goss orientation in order to improve magnetism in the rolling vertical direction. In particular, on the surface layer, as frequency increases, the effect on overall iron loss may increase. When the Goss orientation fraction in the region from the surface to 1/10 t (t: thickness of steel sheet) in the thickness direction exceeds 3 area %, magnetism in the rolling vertical direction may be adversely affected. A method of measuring the Goss orientation fraction may include measuring the cross-section of the steel sheet using the usual EBSD, and ensuring that the number of grains having a minimum grain size exceeding 5 μm and having a grain system having an orientation error angle of 3° or more from the surrounding grains is at least 5,000 or more within the measurement area, which may have statistical significance. In the case of grains measured in a cut form within the measurement area, the fraction may be calculated including the cut area.

The non-oriented electrical steel sheet of the present invention may have a Goss orientation fraction of 5 area % or less in the entire region in the thickness direction. When the Goss orientation fraction of the entire region in the thickness direction exceeds 5 area %, magnetism in the rolling vertical direction may be adversely affected.

The non-oriented electrical steel sheet of the present invention may preferably have an inclusion density in the region from the surface to 1/50 t (t: thickness of the steel sheet) in the thickness direction be equal to or less than the inclusion density in the other regions. The surface portion may be particularly important for assuring high frequency iron loss and may have a large effect on domain movement, such that a low inclusion density in the surface portion may be important for lowering iron loss. In this case, the inclusion density in the surface portion being lower than the inclusion density in the other regions may indicate that inclusions may not be well formed on the surface, and in this case, iron loss in the high frequency rolling vertical direction may be significantly addressed. The inclusion density may be measured using an electron microscope or equivalent equipment (such as SIMS-secondary ion mass spectrometry, AFM-atomic force microscopy, or EPMA-Electron Probe X-ray Micro Analyzer). As for the electron microscope, both a scanning electron microscope and a transmission electron microscope may be used, and the value in an area of 1 mm×1 mm or more, which is the measurement area of the inclusion, or 1 mm×1 mm×sample thickness (mm), and the density values may be compared regardless of the unit by using the same measurement method for the surface portion and the central portion. In this case, the measurement region may not include an insulating coating layer. The number of inclusions may be counted when the size thereof is at least 20 nm or more when converted to a diameter in the spherical equivalent area method, and in the case of a complex inclusion, when the shape is irregular, segmented and connected, and the portions due to non-steel components are connected to each other, the number may be counted as one inclusion and not counted additionally. The maximum size of the inclusion may be 5 μm or less, and even in the case that larger inclusions are present, when the inclusions are counted, density may be obtained with the exception of the larger inclusions. However, even when the area occupied by the coarse inclusion is excluded from the measurement region, the the measurement may be carried out such that the criterian area may be 1 mm×1 mm or more.

As mentioned above, the non-oriented electrical steel sheet of the present invention provided may have an iron loss (W15/1000 L) of 150 W/Kg or lower, and an iron loss (W15/1000 C) of 150 W/Kg or lower. When the condition is not satisfied, high magnetic flux density iron loss may not be excellent, such that it may be difficult to obtain the purpose of the present invention, which is to be used for high output and high efficiency of a motor. Iron loss in the rolling vertical direction may be closely related to the circumferential magnetic measurement of a yoke of the steel sheet. Since a lower value of iron loss may be advantageous, in the present invention, a lower limit of iron loss (W15/1000 L) and iron loss (W15/1000 C) may not be particularly limited. However, a lower limit of iron loss (W15/1000 L) and iron loss (W15/1000 C) may be 50 W/Kg and 50 W/Kg, respectively. W15/1000 may be iron loss measured by the Epstein method under the condition that the maximum magnetic flux is 1.5 T and 1000 Hz. L may indicate the rolling direction, and C may indicate the rolling vertical direction.

Also the non-oriented electrical steel sheet of the present invention may be 2×(W15/1000 C−W15/1000 L)/(W15/1000 C+W15/1000 L)<0.1. When the condition is not satisfied, magnetic anisotropy at high frequency may be high such that it may be difficult to obtain the purpose of the present invention, which is to be used for high output and high efficiency of a motor. The magnetic anisotropy at high frequency may affect the increase in loss when the motor rotates at high speed. A lower value of 2×(W15/1000 C−W15/1000 L)/(W15/1000 C+W15/1000 L) may be advantageous, and thus, in the present invention, a lower limit of 2×(W15/1000 C−W15/1000 L)/(W15/1000 C+W15/1000 L) may not be particularly limited. However, a lower limit of 2×(W15/1000 C−W15/1000 L)/(W15/1000 C+W15/1000 L) may be-0.1.

The non-oriented electrical steel sheet of the present invention may have a thickness of 0.03 to 0.35 mm.

Hereinafter, a method of manufacturing a non-oriented electrical steel sheet according to an embodiment of the present invention may be described.

First, a slab having the aforementioned alloy composition may be heated at 1050 to 1220 °C. When the slab heating temperature is lower than 1050 °C, the temperature difference between the surface and the internal portion of the slab may increase during hot-rolling, passing ability may deteriorate during hot-rolling, and the reduction ratio may not be sufficient during hot-rolling. When the slab heating temperature exceeds 1220 °C, precipitates may be re-dissolved and may be finely precipitated after hot-rolling. A lower limit of the slab heating temperature may be preferably 1080 °C, and more preferably 1100 °C. An upper limit of the slab heating temperature may be preferably 1200 °C, and more preferably 1180 °C.

Thereafter, the slab may be finishing hot-rolled and a hot-rolled sheet may be obtained. The finishing hot-rolling may be performed at 700 to 1050 °C. When the finishing hot-rolling temperature is less than 700 °C, the shape of the hot-rolled sheet may become poor, the deformation may be concentrated on the surface, such that it may be impossible to perform hot-rolling of the steel sheet, and the Goss-like orientation of the surface may increase. When the finishing hot-rolling temperature exceeds 1050 °C, friction between the rolling roll and the sheet surface may increase, the Goss-like orientation may increase, and defects in the sheet shape due to high temperature deformation may occur. A lower limit of the finishing hot-rolling temperature may be preferably 730 °C, more preferably 750 °C, and most preferably 780 °C. An upper limit of the finishing hot-rolling temperature may be preferably 1000 °C, more preferably 960 °C, and most preferably 930 °C. Meanwhile, the thickness of the hot-rolled sheet may be 0.8 to 3 mm.

Thereafter, the hot-rolled sheet may be hot-rolled-sheet-annealed for 30 to 300 seconds at 850 to 1150 °C. When the hot-rolled sheet annealing temperature is lower than 850 °C, the structure may not grow or may grow finely. When the hot-rolled sheet annealing temperature exceeds 1150 °C, magnetic properties may deteriorate, and rolling workability may deteriorate due to deformation of the sheet shape. A lower limit of the hot-rolled sheet annealing temperature may be more preferably 900 °C, and even more preferably 950 °C. An upper limit of the hot-rolled sheet annealing temperature may be preferably 1135 °C, and more preferably 1110 °C. When the hot-rolled sheet annealing time is less than 30 seconds, growth of the grain diameter on the surface and the grain diameter therein may be different, such that the Goss fraction on the surface of the final electrical steel sheet may significantly increase. When the hot-rolled sheet annealing time exceeds 300 seconds, the grains may become coarser, such that the Goss fraction in the entire sheet thickness of the final electrical steel sheet may significantly increase. A lower limit of the hot-rolled sheet annealing time may be preferably 60 seconds, and more preferably 80 seconds. An upper limit of the hot-rolled sheet annealing time may be preferably 180 seconds, and more preferably 150 seconds. The hot-rolled sheet annealing may be performed to increase the orientation which may be advantageous to magnetism when desired, or the hot-rolled sheet annealing may not be performed.

Thereafter, the hot-rolled sheet annealed may be cold-rolled and a cold-rolled sheet may be obtained. It may be preferable to satisfy [Relational expression 2] as below during the cold-rolling.

Highest temperature of cold-rolled sheet surface during cold-rolling<200×cold reduction ratio/100+40 [Relational expression 2]

The temperature of the steel sheet may be increased by residual heat during the obtaining the hot-rolled sheet or the hot-rolled sheet annealing, heating due to mechanical friction of the steel sheet during rolling, or heat supply from the outside. When the maximum temperature of the cold-rolled sheet surface during cold-rolling is 200×cold reduction ratio/100+40 or higher, the shear force may act greatly when the material is deformed, and the fraction of grains having Goss orientation in the steel sheet may increase significantly.

The cold-rolling may be performed with a cold reduction ratio of 35 to 98%. When the cold reduction ratio is less than 35%, the energy stored by processing during cold-rolling may be consumed, and recrystallization may not occur due to the characteristics of steel in which recrystallization occurs, such that magnetism may be deteriorated even after annealing. When the cold reduction ratio exceeds 98%, a high-processing microstructure formed by rolling may be formed, such that iron loss may increase in both the rolling and rolling vertical directions even after the final annealing. A lower limit of the cold reduction ratio may be preferably 55%, more preferably 65%, and most preferably 73%. An upper limit of the cold reduction ratio may be preferably 93%, more preferably 88%, and most preferably 83%. Meanwhile, the cold-rolling may be a single cold-rolling or two or more cold-rolling processes with intermediate annealing therebetween.

The rolling maximum rate in one or more of the first and second passes during cold-rolling may be 3 m/s or higher. When the rolling maximum rate in one or more of the first and second passes during cold-rolling is less than 3 m/s, a strong shear force may be applied to the surface of the steel sheet during rolling, which may increase the nucleation of Goss orientation, and accordingly, the fraction of grains having Goss orientation on the surface of the steel sheet may increase during final annealing. In the present invention, a higher rolling maximum rate in one or more of the first and second passes during cold-rolling may be advantageous, and thus, there is no particular limitation on an upper limit thereof. However, an upper limit of the rolling maximum rate in one or more of the first and second passes during cold-rolling may be 20 m/s.

Thereafter, the cold-rolled sheet may be heated to the final annealing temperature. The heating rate in the temperature range of 300 to 500 °C during heating may preferably be 5 to 150 °C/s. When the heating rate in the temperature range of 300 to 500 °C during heating is less than 5 °C/s, recrystallization of grains having an orientation unfavorable to magnetism may be promoted. When the heating rate in the temperature range of 300 to 500 °C during heating exceeds 150 °C/s, recrystallization of grains having a Goss orientation unfavorable to magnetism in the rolling vertical direction may be greatly promoted. A lower limit of the heating rate may preferably be 7 °C/s, and more preferably 10 °C/s. An upper limit of the heating rate may preferably be 120 °C/s, more preferably 100 °C/s, and most preferably 50 °C/s.

Thereafter, the heated cold-rolled sheet may be final annealed. The final annealing may be performed at 600 to 1150 °C for 10 to 500 seconds. When the final annealing temperature is lower than 600 °C, the Goss fraction in the steel sheet may increase significantly during recrystallization. When the final annealing temperature exceeds 1150 °C, coarse grains may be formed and high-frequency iron loss in the C direction may be deteriorated. A lower limit of the final annealing temperature may be preferably 700 °C, more preferably 730 °C, and most preferably 750 °C. An upper limit of the final annealing temperature may be preferably 1120 °C, more preferably 1100 °C, and most preferably 1050 °C. When the final annealing time is less than 10 seconds, the fraction of grains having Goss fraction in the entire sheet thickness may increase significantly. When the final annealing time exceeds 300 seconds, the high-frequency iron loss may increase significantly due to grain overgrowth. A lower limit of the final annealing time may be preferably 20 seconds, more preferably 30 seconds, and most preferably 35 seconds. An upper limit of the final annealing time may be preferably 240 seconds, more preferably 180 seconds, and most preferably 150 seconds.

It may be preferable that the gas atmosphere during the final annealing may include, by volume %, hydrogen: 15 to 99.99%, oxygen: 0.0001 to 0.0030%, and a remainder of inert gas. By controlling as above, an effect similar to anoxia on the steel sheet surface may be practically obtained. When the hydrogen fraction is less than 15%, the surface of the material of the invention may be oxidized due to insufficient reduction ability. The hydrogen fraction may practically be 100% preferably, but it may be extremely difficult to be used industrially, such that the hydrogen fraction may be limited to 99.99%. When the oxygen fraction is less than 0.0001%, an extremely small portion of the steel sheet surface may combine with oxygen, such that a local oxide layer may be formed, which may create surface unevenness. When the oxygen fraction exceeds 0.0030%, a wide oxide layer may be formed on the surface, which may deteriorate magnetism and may promote the nucleation of grains having a Goss orientation on the surface, thereby increasing the surface fraction. In the present invention, the type of the inert gas may not be particularly limited, and all types used in the relevant technical field may be used. For example, nitrogen or argon may be used.

Preferably, the oxygen content in the gas atmosphere in the temperature range of 800 to 1100 °C during the final annealing may be 1 to 1.5 times greater than the oxygen content in the temperature range of 500 to 750 °C. By controlling as above, the growth of grains in the Goss orientation may not be induced. When the condition is not satisfied, an oxide layer may be formed in a wide region of the surface and an oxide combined with oxygen may be created to a deeper thickness.

Forming an insulating layer may be further included after the final annealing. The method of forming the insulating layer may be widely known in the field of non-oriented electrical steel sheet technology, and thus, a detailed description thereof may not be provided.

### MODE FOR INVENTION

Hereinafter, the present disclosure may be described more specifically through embodiments. However, it should be noted that the embodiments below are merely intended to describe the present disclosure in greater detail based on embodiments, and are not intended to limit the scope of the rights of the present disclosure. This may be because the scope of rights of the present invention is determined by matters described in the claims and matters reasonably inferred therefrom.

### Embodiment

A slab having the alloy composition listed in Tables 1 and 2 below was prepared, and a non-oriented electrical steel sheet was manufactured using the manufacturing conditions listed in Tables 3 and 4 below. The remainder in the gas atmosphere in the temperature range of 500 to 750 during the final annealing was nitrogen.

The Goss orientation fraction and electrical properties of the non-oriented electrical steel sheet manufactured in this manner were measured, and the results are listed in Tables 4 to 6 below.

The Goss orientation fraction in the surface layer (the region from the surface to 1/10 t (t: the thickness of the steel sheet) in the thickness direction) and the entire region in the thickness direction were measured using EBSD. In order to confirm the Goss orientation fraction according to thickness, the RD-ND plane was observed, and the EBSD measurement plane was separated and analyzed for the upper and lower surfaces, which are 1/10 of the total thickness. In order to ensure statistical reliability, the cross-sections of 100 samples were measured, and the texture according to thickness in each sample measurement was measured, averaged, and evaluated as the Goss orientation fraction of 1/10 t.

The inclusion density of the surface portion (the region from the surface to 1/50 t (t: thickness of the steel sheet) in the thickness direction) and other regions were measured using SEM for the surface of the steel sheet. EDS was measured for points having contrast in the image using SEM, and points having component values significantly higher than the composition of Fe and the steel sheet were considered as inclusions regardless of the size of the region creating contrast. In this case, points having 5% or more of oxygen were considered as oxides, points having 1% or more of N were considered as nitrides, points having 1% or more of C were considered as carbides, and points having 1% or more S were considered as sulfides, and the total content thereof was measured.

Iron loss (W15/1000 L) and iron loss (W15/1000 C) were measured using the Epstein measurement method, which is commonly used for quantitative measurement of an electrical steel sheet. The sample was cut with a cutter such that the L-direction sample had a length of 305 mm in the L direction and 30 mm in the C direction. The C-direction sample had a length of 305 mm in the C direction and 30 mm in the L direction.

TABLE 1

| | |
|---|---|
| Steel | Alloy composition (weight %) |

| type | Si | Al | Mn | Cr | S | P | Sn | C |
|---|---|---|---|---|---|---|---|---|
| Inventive | 3.23 | 1.06 | 0.02 | 0.13 | 0.0007 | 0.006 | 0.048 | 0.0043 |
| steel 1 | | | | | | | | |
| Inventive | 4.13 | 2.15 | 0.05 | 0.06 | 0.0006 | 0.007 | 0.010 | 0.0031 |
| steel 2 | | | | | | | | |
| Inventive | 4.01 | 0.29 | 0.44 | 0.32 | 0.0018 | 0.012 | 0.015 | 0.0032 |
| steel 3 | | | | | | | | |
| Inventive | 2.69 | 1.02 | 1.40 | 0.15 | 0.0028 | 0.007 | 0.041 | 0.0036 |
| steel 4 | | | | | | | | |
| Inventive | 2.88 | 1.07 | 0.64 | 2.50 | 0.0005 | 0.011 | 0.036 | 0.0039 |
| steel 5 | | | | | | | | |
| Inventive | 4.00 | 0.27 | 0.83 | 0.18 | 0.0022 | 0.008 | 0.118 | 0.0029 |
| steel 6 | | | | | | | | |
| Inventive | 4.14 | 0.48 | 0.34 | 0.04 | 0.0017 | 0.011 | 0.094 | 0.0028 |
| steel 7 | | | | | | | | |
| Inventive | 5.48 | 1.15 | 1.30 | 0.07 | 0.0008 | 0.010 | 0.060 | 0.0042 |
| steel 8 | | | | | | | | |
| Inventive | 2.85 | 1.62 | 0.43 | 0.17 | 0.0022 | 0.010 | 0.107 | 0.0048 |
| steel 9 | | | | | | | | |
| Inventive | 3.48 | 0.59 | 0.20 | 0.01 | 0.0005 | 0.010 | 0.075 | 0.0047 |
| steel 10 | | | | | | | | |
| Inventive | 4.33 | 0.37 | 0.64 | 0.04 | 0.0008 | 0.008 | 0.048 | 0.0041 |
| steel 11 | | | | | | | | |
| Inventive | 3.65 | 1.75 | 0.89 | 0.33 | 0.0020 | 0.011 | 0.116 | 0.0038 |
| steel 12 | | | | | | | | |
| Inventive | 4.50 | 1.99 | 0.73 | 0.03 | 0.0016 | 0.009 | 0.065 | 0.0041 |
| steel 13 | | | | | | | | |
| Inventive | 4.88 | 1.20 | 1.43 | 0.04 | 0.0027 | 0.007 | 0.107 | 0.0039 |
| steel 14 | | | | | | | | |
| Inventive | 4.29 | 1.52 | 1.39 | 0.14 | 0.0012 | 0.006 | 0.010 | 0.0041 |
| steel 15 | | | | | | | | |
| Inventive | 3.10 | 1.07 | 0.64 | 0.04 | 0.0020 | 0.011 | 0.036 | 0.0029 |
| steel 16 | | | | | | | | |

| Steel | Alloy composition (weight %) | | | | | | | | |
|---|---|---|---|---|---|---|---|---|---|
| type | N | O | Ti | Mo | B | V | Ca | Nb | Mg |
| Inventive | 0.0033 | 0.0005 | 0.0014 | 0.0047 | 0.0011 | 0.0012 | 0.0016 | 0.0007 | 0.0022 |
| steel 1 | | | | | | | | | |
| Inventive | 0.0034 | 0.0002 | 0.0006 | 0.0022 | 0.0005 | 0.0004 | 0.0015 | 0.0047 | 0.0007 |
| steel 2 | | | | | | | | | |
| Inventive | 0.0020 | 0.0006 | 0.0010 | 0.0048 | 0.0011 | 0.0013 | 0.0003 | 0.0009 | 0.0005 |
| steel 3 | | | | | | | | | |
| Inventive | 0.0046 | 0.0002 | 0.0012 | 0.0047 | 0.0001 | 0.0007 | 0.0006 | 0.0018 | 0.0031 |
| steel 4 | | | | | | | | | |
| Inventive | 0.0046 | 0.0004 | 0.0017 | 0.0003 | 0.0007 | 0.0003 | 0.0013 | 0.0022 | 0.0019 |
| steel 5 | | | | | | | | | |
| Inventive | 0.0045 | 0.0005 | 0.0019 | 0.0021 | 0.0009 | 0 | 0.0006 | 0.0007 | 0.0028 |
| steel 6 | | | | | | | | | |
| Inventive | 0.0034 | 0.0004 | 0.0007 | 0.0025 | 0.0008 | 0.0008 | 0.0010 | 0.0035 | 0.0029 |
| steel 7 | | | | | | | | | |
| Inventive | 0.0041 | 0.0005 | 0.0016 | 0.0008 | 0.0008 | 0.0010 | 0.0013 | 0.0028 | 0.0009 |
| steel 8 | | | | | | | | | |
| Inventive | 0.0024 | 0.0005 | 0.0005 | 0.0017 | 0.0008 | 0.0001 | 0.0013 | 0.0030 | 0.0006 |
| steel 9 | | | | | | | | | |
| Inventive | 0.0034 | 0.0004 | 0.0017 | 0.0017 | 0.0011 | 0.0008 | 0.0014 | 0.0018 | 0.0047 |
| steel 10 | | | | | | | | | |
| Inventive | 0.0044 | 0.0007 | 0.0012 | 0.0017 | 0.0006 | 0.0009 | 0.0012 | 0.0007 | 0.0010 |
| steel 11 | | | | | | | | | |
| Inventive | 0.0018 | 0.0007 | 0.0009 | 0.0025 | 0.0006 | 0.0009 | 0.0003 | 0.0025 | 0.0028 |
| steel 12 | | | | | | | | | |
| Inventive | 0.0010 | 0.0008 | 0.0020 | 0.0029 | 0.0005 | 0.0013 | 0.0016 | 0.0006 | 0.0035 |
| steel 13 | | | | | | | | | |
| Inventive | 0.0036 | 0.0007 | 0.0010 | 0.0030 | 0.0010 | 0.0009 | 0.0007 | 0.0016 | 0.0031 |
| steel 14 | | | | | | | | | |
| Inventive | 0.0031 | 0.0002 | 0.0017 | 0.0033 | 0.0011 | 0.0004 | 0.0010 | 0.0035 | 0.0015 |
| steel 15 | | | | | | | | | |
| Inventive | 0.0020 | 0.0006 | 0.0010 | 0.0002 | 0.0011 | 0.0013 | 0.0003 | 0.0009 | 0.0005 |
| steel 16 | | | | | | | | | |

TABLE 2

| Steel | Alloy composition (weight %) | | | | | | | | |
|---|---|---|---|---|---|---|---|---|---|
| type | N | 0 | Ti | Mo | B | V | Ca | Nb | Mg |
| Inventive | 0.0033 | 0.0005 | 0.0014 | 0.0047 | 0.0011 | 0.0012 | 0.0016 | 0.0007 | 0.0022 |
| steel 1 | | | | | | | | | |
| Inventive | 0.0034 | 0.0002 | 0.0006 | 0.0022 | 0.0005 | 0.0004 | 0.0015 | 0.0047 | 0.0007 |
| steel 2 | | | | | | | | | |
| Inventive | 0.0020 | 0.0006 | 0.0010 | 0.0048 | 0.0011 | 0.0013 | 0.0003 | 0.0009 | 0.0005 |
| steel 3 | | | | | | | | | |
| Inventive | 0.0046 | 0.0002 | 0.0012 | 0.0047 | 0.0001 | 0.0007 | 0.0006 | 0.0018 | 0.0031 |
| steel 4 | | | | | | | | | |
| Inventive | 0.0046 | 0.0004 | 0.0017 | 0.0003 | 0.0007 | 0.0003 | 0.0013 | 0.0022 | 0.0019 |
| steel 5 | | | | | | | | | |
| Inventive | 0.0045 | 0.0005 | 0.0019 | 0.0021 | 0.0009 | 0 | 0.0006 | 0.0007 | 0.0028 |
| steel 6 | | | | | | | | | |
| Inventive | 0.0034 | 0.0004 | 0.0007 | 0.0025 | 0.0008 | 0.0008 | 0.0010 | 0.0035 | 0.0029 |
| steel 7 | | | | | | | | | |
| Inventive | 0.0041 | 0.0005 | 0.0016 | 0.0008 | 0.0008 | 0.0010 | 0.0013 | 0.0028 | 0.0009 |
| steel 8 | | | | | | | | | |
| Inventive | 0.0024 | 0.0005 | 0.0005 | 0.0017 | 0.0008 | 0.0001 | 0.0013 | 0.0030 | 0.0006 |
| steel 9 | | | | | | | | | |
| Inventive | 0.0034 | 0.0004 | 0.0017 | 0.0017 | 0.0011 | 0.0008 | 0.0014 | 0.0018 | 0.0047 |
| steel 10 | | | | | | | | | |
| Inventive | 0.0044 | 0.0007 | 0.0012 | 0.0017 | 0.0006 | 0.0009 | 0.0012 | 0.0007 | 0.0010 |
| steel 11 | | | | | | | | | |
| Inventive | 0.0018 | 0.0007 | 0.0009 | 0.0025 | 0.0006 | 0.0009 | 0.0003 | 0.0025 | 0.0028 |
| steel 12 | | | | | | | | | |
| Inventive | 0.0010 | 0.0008 | 0.0020 | 0.0029 | 0.0005 | 0.0013 | 0.0016 | 0.0006 | 0.0035 |
| steel 13 | | | | | | | | | |
| Inventive | 0.0036 | 0.0007 | 0.0010 | 0.0030 | 0.0010 | 0.0009 | 0.0007 | 0.0016 | 0.0031 |
| steel 14 | | | | | | | | | |
| Inventive | 0.0031 | 0.0002 | 0.0017 | 0.0033 | 0.0011 | 0.0004 | 0.0010 | 0.0035 | 0.0015 |
| steel 15 | | | | | | | | | |
| Inventive | 0.0020 | 0.0006 | 0.0010 | 0.0002 | 0.0011 | 0.0013 | 0.0003 | 0.0009 | 0.0005 |
| steel 16 | | | | | | | | | |

TABLE 3

| | | | | | Hot- | Hot- | | | Cold-rolled |
|---|---|---|---|---|---|---|---|---|---|
| | | | Finishing | Hot- | rolled | rolled | | Cold- | sheet surface |
| | | Slab | hot- | rolled | sheet | sheet | Cold | rolled | maximum |
| | | heating | rolling | sheet | annealing | annealing | rolling | sheet | temperature in |
| | Steel | temperature | temperature | thickness | temperature | time | reduction | thickness | cold-rolling |
| Classification | type | (°C) | (°C) | (mm) | (°C) | (min) | (%) | (mm) | (°C) |
| Inventive | Inventive | 1150 | 794 | 0.8 | 930 | 70 | 89 | 0.09 | 105 |
| example 1 | steel 1 | | | | | | | | |
| Inventive | Inventive | 1170 | 942 | 1.6 | 1092 | 175 | 94 | 0.09 | 185 |
| example 2 | steel 2 | | | | | | | | |
| Inventive | Inventive | 1080 | 924 | 1.6 | 1091 | 88 | 94 | 0.09 | 183 |
| example 3 | steel 3 | | | | | | | | |
| Inventive | Inventive | 1080 | 996 | 2.0 | 1100 | 72 | 95 | 0.10 | 189 |
| example 4 | steel 4 | | | | | | | | |
| Inventive | Inventive | 1080 | 852 | 1.2 | 930 | 60 | 92 | 0.10 | 132 |
| example 5 | steel 5 | | | | | | | | |
| Inventive | Inventive | 1200 | 930 | 1.5 | 1050 | 70 | 92 | 0.12 | 153 |
| example 6 | steel 6 | | | | | | | | |
| Inventive | Inventive | 1080 | 852 | 1.2 | 930 | 99 | 88 | 0.14 | 136 |
| example 7 | steel 7 | | | | | | | | |
| Inventive | Inventive | 1080 | 816 | 1.0 | 850 | 104 | 83 | 0.17 | 152 |
| example 8 | steel 8 | | | | | | | | |
| Inventive | Inventive | 1140 | 828 | 1.0 | 850 | 83 | 83 | 0.17 | 104 |
| example 9 | steel 9 | | | | | | | | |
| Inventive | Inventive | 1090 | 818 | 1.0 | 850 | 118 | 83 | 0.17 | 109 |
| example 10 | steel 10 | | | | | | | | |
| Inventive | Inventive | 1140 | 828 | 1.0 | 850 | 60 | 82 | 0.18 | 113 |
| example 11 | steel 11 | | | | | | | | |
| Inventive | Inventive | 1100 | 892 | 1.4 | 1000 | 60 | 87 | 0.18 | 174 |
| example 12 | steel 12 | | | | | | | | |
| Comparative | Inventive | 1110 | 822 | 1.0 | 850 | 60 | 81 | 0.19 | 114 |
| example 1 | steel 13 | | | | | | | | |
| Inventive | Inventive | 1070 | 814 | 1.0 | 850 | 129 | 81 | 0.19 | 123 |
| example 13 | steel 14 | | | | | | | | |
| Inventive | Inventive | 1070 | 994 | 2.0 | 1150 | 125 | 87 | 0.26 | 195 |
| example 14 | steel 15 | | | | | | | | |
| Comparative | Inventive | 1000 | 700 | 1.2 | 1000 | 100 | 83 | 0.20 | 145 |
| example 2 | steel 16 | | | | | | | | |
| Comparative | Inventive | 1150 | 920 | 2.0 | 1000 | 600 | 90 | 0.20 | 155 |
| example 3 | steel 16 | | | | | | | | |
| Comparative | Inventive | 1150 | 920 | 2.0 | 1100 | 8 | 90 | 0.20 | 155 |
| example 4 | steel 16 | | | | | | | | |
| Comparative | Inventive | 1150 | 920 | 2.0 | 1000 | 100 | 90 | 0.20 | 255 |
| example 5 | steel 16 | | | | | | | | |
| Comparative | Inventive | 1150 | 700 | 1.5 | 1000 | 30 | 87 | 0.20 | 260 |
| example 6 | steel 16 | | | | | | | | |
| Comparative | Inventive | 1150 | 900 | 2.0 | 1000 | 100 | 90 | 0.20 | 265 |
| example 7 | steel 16 | | | | | | | | |
| Comparative | Inventive | 1150 | 930 | 2.5 | 1000 | 100 | 92 | 0.20 | 254 |
| example 8 | steel 16 | | | | | | | | |
| Comparative | Inventive | 1250 | 1062 | 2.5 | 1000 | 100 | 92 | 0.20 | 295 |
| example 9 | steel 16 | | | | | | | | |
| Comparative | Inventive | 1250 | 930 | 2.0 | 1000 | 100 | 90 | 0.20 | 235 |
| example 10 | steel 16 | | | | | | | | |

TABLE 4

| | | | | | | | | | A ratio of oxygen content |
|---|---|---|---|---|---|---|---|---|---|
| | | First pass and | | | | | | | in a gas atmosphere in |
| | | second pass, | Heating | | | Gas atmosphere in | | | temperature range of |
| | | one or more | rate in | | | temperature range of | | | 800 to 1100 °C to |
| | | of the rolling | temperature | Final | Final | 500 to 750 °C during | | | oxygen content in |
| | | maximum rate in | range of | annealing | annealing | final annealing | | | temperature range of |
| | Steel | cold-rolling | 300 to 500 °C | temperature | time | (volume %) | | | 500 to 750°C during |
| Classification | type | (m/s) | (°C/s) | (°C) | (min) | Hydrogen | Oxygen | Remainder | final annealing |
| Inventive | Inventive | 8 | 22.7 | 978 | 173 | 99.9 | 0.0001 | N₂ | 1.10 |
| example 1 | steel 1 | | | | | | | | |
| Inventive | Inventive | 8 | 26. | 1030 | 121 | 20.0 | 0.0015 | N₂ | 1.05 |
| example 2 | steel 2 | | | | | | | | |
| Inventive | Inventive | 5 | 25.1 | 987 | 199 | 25.0 | 0.0010 | N₂ | 1.20 |
| example 3 | steel 3 | | | | | | | | |
| Inventive | Inventive | 8 | 7.3 | 1101 | 88 | 25.0 | 0.0002 | N₂ | 1.20 |
| example 4 | steel 4 | | | | | | | | |
| Inventive | Inventive | 9 | 10.6 | 1099 | 160 | 30.0 | 0.0003 | N₂ | 1.15 |
| example 5 | steel 5 | | | | | | | | |
| Inventive | Inventive | 9 | 11.4 | 828 | 131 | 35.0 | 0.0002 | N₂ | 1.10 |
| example 6 | steel 6 | | | | | | | | |
| Inventive | Inventive | 7 | 17.8 | 853 | 128 | 35.0 | 0.0001 | N₂ | 1.05 |
| example 7 | steel 7 | | | | | | | | |
| Inventive | Inventive | 9 | 27.9 | 1063 | 50 | 30.0 | 0.0005 | N₂ | 1.05 |
| example 8 | steel 8 | | | | | | | | |
| Inventive | Inventive | 9 | 7.5 | 976 | 196 | 30.0 | 0.0004 | N₂ | 1.10 |
| example 9 | steel 9 | | | | | | | | |
| Inventive | Inventive | 9 | 18.9 | 965 | 217 | 30.0 | 0.0015 | N₂ | 1.05 |
| example 10 | steel 10 | | | | | | | | |
| Inventive | Inventive | 7 | 6.5 | 811 | 158 | 30.0 | 0.0005 | N₂ | 1.10 |
| example 11 | steel 11 | | | | | | | | |
| Inventive | Inventive | 9 | 4.9 | 802 | 252 | 30.0 | 0.0003 | N₂ | 1.10 |
| example 12 | steel 12 | | | | | | | | |
| Comparative | Inventive | 18 | 23.3 | 1091 | 122 | 30.0 | 0.0042 | N₂ | 1.05 |
| example 1 | steel 13 | | | | | | | | |
| Inventive | Inventive | 9 | 5.7 | 837 | 221 | 30.0 | 0.0003 | N₂ | 1.05 |
| example 13 | steel 14 | | | | | | | | |
| Inventive | Inventive | 9 | 9.7 | 994 | 159 | 30.0 | 0.0001 | N₂ | 1.05 |
| example 14 | steel 15 | | | | | | | | |
| Comparative | Inventive | 5 | 4.0 | 800 | 12 | 20.0 | 0.0045 | N₂ | 1.30 |
| example 2 | steel 16 | | | | | | | | |
| Comparative | Inventive | 5 | 2.0 | 800 | 120 | 20.0 | 0.0035 | N₂ | 1.40 |
| example 3 | steel 16 | | | | | | | | |
| Comparative | Inventive | 5 | 3.0 | 800 | 120 | 30.0 | 0.0035 | N₂ | 1.25 |
| example 4 | steel 16 | | | | | | | | |
| Comparative | Inventive | 3 | 3.0 | 800 | 100 | 20.0 | 0.0035 | N₂ | 1.30 |
| example 5 | steel 16 | | | | | | | | |
| Comparative | Inventive | 5 | 165.0 | 800 | 120 | 10.0 | 0.0045 | N₂ | 1.50 |
| example 6 | steel 16 | | | | | | | | |
| Comparative | Inventive | 7 | 5.0 | 800 | 60 | 30.0 | 0.0065 | N₂ | 2.00 |
| example 7 | steel 16 | | | | | | | | |
| Comparative | Inventive | 3 | 3.0 | 800 | 120 | 20.0 | 0.0150 | N₂ | 1.70 |
| example 8 | steel 16 | | | | | | | | |
| Comparative | Inventive | 7 | 4.0 | 1000 | 360 | 15.0 | 0.0150 | N₂ | 1.60 |
| example 9 | steel 16 | | | | | | | | |
| Comparative | Inventive | 6 | 4.0 | 800 | 40 | 15.0 | 0.0045 | N₂ | 1.50 |
| example 10 | steel 16 | | | | | | | | |

TABLE 5

| | | | | Inclusion | | | |
|---|---|---|---|---|---|---|---|
| | | | Surface | density | | | |
| | Surface | Entire | portion | other than | | | |
| | portion | region | inclusion | surface | | | |
| | Goss | Goss | density | portion | | | 2 × (W15/1000C − |
| | orientation | orientation | (number of | (number of | Iron loss | Iron loss | W15/1000L)/ |
| | fraction | fraction | inclusions/ | inclusions/ | (W15/1000L) | (W15/1000C) | (W15/1000C + |
| Classification | (area %) | (area %) | mm²) | mm²) | (W/Kg) | (W/Kg) | W15/1000L) |
| Inventive | 2.9 | 2.3 | 80 | 334 | 87.3 | 90.6 | 0.037 |
| example 1 | | | | | | | |
| Inventive | 2.5 | 3.2 | 72 | 185 | 72.2 | 76.1 | 0.053 |
| example 2 | | | | | | | |
| Inventive | 2.5 | 1.4 | 2. | 137 | 83.7 | 85.7 | 0.025 |
| example 3 | | | | | | | |
| Inventive | 2.1 | 1.7 | 18 | 271 | 85 | 86.9 | 0.022 |
| example 4 | | | | | | | |
| Inventive | 2.5 | 2 | 3 | 68 | 90.3 | 93 | 0.029 |
| example 5 | | | | | | | |
| Inventive | 2.9 | 3.9 | 75 | 135 | 91.6 | 98.8 | 0.076 |
| example 6 | | | | | | | |
| Inventive | 0.9 | 0.7 | 89 | 233 | 102.2 | 102 | −0.002 |
| example 7 | | | | | | | |
| Inventive | 1.3 | 1 | 74 | 184 | 88.3 | 88.8 | 0.006 |
| example 8 | | | | | | | |
| Inventive | 3 | 2.1 | 63 | 160 | 112.3 | 116.4 | 0.036 |
| example 9 | | | | | | | |
| Inventive | 2.2 | 3 | 2 | 186 | 122.1 | 129.4 | 0.058 |
| example 10 | | | | | | | |
| Inventive | 2.5 | 1.6 | 74 | 172 | 111.3 | 114.1 | 0.025 |
| example 11 | | | | | | | |
| Inventive | 2 | 3.6 | 79 | 141 | 103.2 | 109.8 | 0.062 |
| example 12 | | | | | | | |
| Comparative | 4.5 | 4.9 | 274 | 36 | 97.4 | 110.2 | 0.123 |
| example 1 | | | | | | | |
| Inventive | 2.8 | 2.7 | 63 | 400 | 97.3 | 101.4 | 0.041 |
| example 13 | | | | | | | |
| Inventive | 1.2 | 0.8 | 26 | 127 | 115.2 | 115.2 | 0 |
| example 14 | | | | | | | |
| Comparative | 4.9 | 6.7 | 378 | 224 | 95.4 | 109.6 | 0.139 |
| example 2 | | | | | | | |
| Comparative | 5.7 | 7.9 | 381 | 226 | 95 | 110 | 0.146 |
| example 3 | | | | | | | |
| Comparative | 5.7 | 7.4 | 388 | 223 | 95.1 | 109.9 | 0.144 |
| example 4 | | | | | | | |
| Comparative | 8.8 | 11.8 | 373 | 212 | 94 | 111 | 0.166 |
| example 5 | | | | | | | |
| Comparative | 16.7 | 22 | 282 | 155 | 92.3 | 112.7 | 0.199 |
| example 6 | | | | | | | |
| Comparative | 6.6 | 8.7 | 386 | 222 | 94.7 | 110.3 | 0.152 |
| example 7 | | | | | | | |
| Comparative | 10 | 13.5 | 361 | 204 | 93.6 | 111.4 | 0.174 |
| example 8 | | | | | | | |
| Comparative | 15 | 20.8 | 296 | 166 | 92.5 | 112.5 | 0.195 |
| example 9 | | | | | | | |
| Comparative | 13.2 | 17.4 | 327 | 181 | 92.9 | 112.1 | 0.187 |
| example 10 | | | | | | | |

As indicated in Tables 1 to 5, invention examples 1 to 14, which satisfied the alloy composition and manufacturing conditions of the present invention, satisfied the Goss orientation fraction and inclusion characteristics which the present invention aims to obtain, such that the iron loss and also magnetic anisotropy were excellent.

Comparative examples 1 to 10 did not satisfy the manufacturing conditions of the present invention such that the Goss orientation fraction or inclusion characteristics which the present invention aims to obtain were not satisfied, such that iron loss was excellent but magnetic anisotropy was degraded.

1. A non-oriented electrical steel sheet, comprising:
by weight %, Si: 1.5 to 6.5%, Al: 0.0005 to 3.5%, Mn: 0.01 to 3.0%, Cr: 0.005 to 5.0%, S: 0.0005 to 0.03%, and a balance of Fe and inevitable impurities,
wherein a Goss orientation fraction in a region from a surface to 1/10 t (t: thickness of the steel sheet) in a thickness direction is 3 area % or less, and
wherein a density of inclusions in a region from a surface to 1/50 t (t: thickness of the steel sheet) in the thickness direction is equal to or less than a density of inclusions in the other region.

2. The non-oriented electrical steel sheet of claim 1, wherein the non-oriented electrical steel sheet further includes one or more of P: 0.005 to 0.08% and Sn: 0.01 to 0.2%.

3. The non-oriented electrical steel sheet of claim 1, wherein the non-oriented electrical steel sheet further includes one or more of C: 0.005% or less (excluding 0%), N: 0.005% or less (excluding 0%), 0:0.005% or less (excluding 0%) and Ti: 0.01% or less (excluding 0%).

4. The non-oriented electrical steel sheet of claim 1, wherein the non-oriented electrical steel sheet further includes one or more of Mo: 0.1% or less (excluding 0%), B: 0.0050% or less (excluding 0%), V: 0.050% or less (excluding 0%), Ca: 0.010% or less (excluding 0%), Nb: 0.0050% or less (excluding 0%) and Mg: 0.0050% or less (excluding 0%).

5. The non-oriented electrical steel sheet of claim 1, wherein the non-oriented electrical steel sheet further includes one or more of Sb: 0.1% or less (excluding 0%), Ni: 0.05% or less (excluding 0%), Cu: 0.005 to 0.2% and Zn: 0.01% or less (excluding 0%).

6. The non-oriented electrical steel sheet of claim 1, wherein the non-oriented electrical steel sheet further includes 0.20% or less (excluding 0%) of one or more of Bi, Pb, Ge and As individually or in combination.

7. The non-oriented electrical steel sheet of claim 1, wherein the non-oriented electrical steel sheet satisfies relational expression 1 as below:
Si>Al+Mn [Relational expression 1]

8. The non-oriented electrical steel sheet of claim 1, wherein, in the non-oriented electrical steel sheet, a Goss orientation fraction in the thickness direction in an entire region is 5 area % or less.

9. The non-oriented electrical steel sheet of claim 1, wherein the non-oriented electrical steel sheet has an iron loss (W15/1000 L) of 150 W/Kg or lower, and an iron loss (W15/1000 C) of 150 W/Kg or lower.

10. The non-oriented electrical steel sheet of claim 1, wherein the non-oriented electrical steel sheet satisfies 2×(W15/1000 C−W15/1000 L)/(W15/1000 C+W15/1000 L)<0.1.

11. A method of manufacturing a non-oriented electrical steel sheet, the method comprising:
heating a slab including, by weight %, Si: 1.5 to 6.5%, Al: 0.0005 to 3.5%, Mn: 0.01 to 3.0%, Cr: 0.005 to 5.0%, S: 0.0005 to 0.03%, and a balance of Fe and inevitable impurities at 1050 to 1220 °C;
finishing hot-rolling the slab and obtaining a hot-rolled sheet;
hot-rolled sheet annealing the hot-rolled sheet for 30 to 300 seconds at 850 to 1150 °C;
cold-rolling the hot-rolled sheet annealed hot-rolled sheet and obtaining a cold-rolled sheet;
heating the cold-rolled sheet; and
final annealing the heated cold-rolled sheet at 600 to 1150 °C for 10 to 300 seconds,
wherein, in the cold-rolling, [Relational expression 2] is satisfied,
wherein, in the heating, a heating rate in a temperature range of 300 to 500 °C is 5 to 150 °C/s,
wherein, in the final annealing, a gas atmosphere includes, by volume %, hydrogen: 15 to 99.99%, oxygen: 0.0001 to 0.0030%, and a remainder of inert gas, and
wherein, in the final annealing, an oxygen content in the gas atmosphere in a temperature range of 800 to 1100 °C is 1 to 1.5 times higher than an oxygen content in a temperature range of 500 to 750 °C:
Highest temperature on surface of cold-rolled sheet during cold rolling<200×cold reduction ratio/100+40 [Relational expression 2]

12. The non-oriented electrical steel sheet of claim 11, wherein the slab further includes one or more of P: 0.005 to 0.08% and Sn: 0.01 to 0.2%.

13. The method of claim 12, wherein the slab further includes one or more of C: 0.005% or less (excluding 0%), N: 0.005% or less (excluding 0%), 0:0.005% or less (excluding 0%) and Ti: 0.01% or less (excluding 0%).

14. The method of claim 12, wherein the slab further includes one or more of Mo: 0.1% or less (excluding 0%), B: 0.0050% or less (excluding 0%), V: 0.050% or less (excluding 0%), Ca: 0.010% or less (excluding 0%), Nb: 0.0050% or less (excluding 0%) and Mg: 0.0050% or less (excluding 0%).

15. The method of claim 12, wherein the slab further includes one or more of Sb: 0.1% or less (excluding 0%), Ni: 0.05% or less (excluding 0%), Cu: 0.005 to 0.2% and Zn: 0.01% or less (excluding 0%).

16. The method of claim 11, wherein the slab further includes 0.20% or less (excluding 0%) of one or more of Bi, Pb, Ge and As individually or in combination.

17. The method of claim 11, wherein the slab satisfies relational expression 1 as below:
Si>Al+Mn [Relational expression 1]

18. The method of claim 11, wherein the finishing hot-rolling is performed at 700 to 1050 °C.

19. The method of claim 11, wherein the cold-rolling is performed with a cold reduction ratio of 35 to 98%.

20. The method of claim 11, wherein, in the cold rolling, a maximum rolling rate in one or more of first and second passes is 3 m/s or higher.
